(19) United States
(12) Patent Application Publication
(10) Pub. No.: US 2026/0102309 A1
(43) Pub. Date: Apr. 16, 2026

(54) Crutch with Integrated Fold-Out Sling, Telescoping Frame for Compact Transport, and Leg Elevation Mechanism

(71) Applicant: Thomas Jefferson University, Philadelphia, PA (US)

(72) Inventors: Samuel Elesinmogun, Philadelphia, PA (US); Haig Manoukian, Philadelphia, PA (US); Rabiul Rafi, Philadelphia, PA (US); Mason Meo, Philadelphia, PA (US)

(21) Appl. No.: 19/355,190

(22) Filed: Oct. 10, 2025

Related U.S. Application Data
(60) Provisional application No. 63/705,667, filed on Oct. 10, 2024.

(51) Int. Cl. A61H 3/02

(52) U.S. Cl. CPC A61H 3/02; A61H 2003/0205; A61H 2201/0161; A61H 2201/1635; A61H 2201/1642

(57) ABSTRACT

A crutch device includes a first strut portion connected to a second strut portion with a hinge and a flexible sling connected to the first and second strut portions, wherein the device is configurable between a crutch mode and a sling mode. Also described herein is a crutch device comprising a first strut portion, wherein the first strut portion comprises an elongated structure with a first end and second end; a second strut portion, wherein the second strut portion is connected to the first strut portion via a hinge, and the second strut portion comprises a first elongated structure and a second elongated structure, each with a first end and second end; and a flexible sling connected to the first and second strut portions, wherein the device is configurable between a crutch mode, a sling mode and a compact mode.

### CROSS-REFERENCE TO RELATED APPLICATIONS

This application claims priority to U.S. Provisional Application No. 63/705,667 filed on Oct. 10, 2024, the contents of which are incorporated herein by reference in its entirety.

### BACKGROUND OF THE INVENTION

There are over 100,000 lower limb injuries each year and many of them require the use of crutches. When recovering from lower limb injuries healthcare providers encourage patients to elevate their legs to reduce pain and swelling, but this is difficult to do outside of the home where items such as chairs or pillows aren't always readily available.

Additionally, conventional crutches are bulky and awkward to transport, especially when space is limited, such as in vehicles, public transportation, or small living areas. To overcome these issues, a crutch design is needed that allows for adequate leg elevation and a more compact form when not in use.

Thus, there is a need in the art for new crutch designs. The present invention meets this need.

### SUMMARY OF THE INVENTION

Described herein is a crutch device includes a first strut portion connected to a second strut portion with a hinge and a flexible sling connected to the first and second strut portions, wherein the device is configurable between a crutch mode and a sling mode. In some embodiments, the flexible sling is positioned substantially parrel to the ground when the device is configured to the sling mode. In some embodiments, a foot portion of the first strut portion extends below a foot portion of the second strut portion when the device is configured to the crutch mode In some embodiments, the first strut portion is formed from an elongate tube or structure, and the second strut portion is formed from first and second elongate tubes or structures. In some embodiments, the foot portions of the first and second strut portions form a tripod stance when the device is configured to the sling mode. In some embodiments, the device further comprises a hand grip portion attached to the first strut portion. In some embodiments, any portion of the first and second strut portions are adjustable, extendable or telescoping. In some embodiments, the flexible sling is composed of a fabric, cushioned fabric, plastic, leather, or any combinations thereof. In some embodiments, the sling has a length ranging between about 4″ and 14″. In some embodiments, the first strut comprises an underarm support.

Also described herein is a crutch device comprising a first strut portion, wherein the first strut portion comprises an elongated structure with a first end and second end; a second strut portion, wherein the second strut portion is connected to the first strut portion via a hinge, and the second strut portion comprises a first elongated structure and a second elongated structure, each with a first end and second end; and a flexible sling connected to the first and second strut portions, wherein the device is configurable between a crutch mode, a sling mode and a compact mode. In some embodiments, the first end of the first strut portion comprises an underarm support. In some embodiments, the first strut portion further comprises a hand grip portion. In some embodiments, the second strut portion comprises a locking mechanism configured to engage and lock with the first strut portion in both the crutch mode and the compact mode. In some embodiments, the locking mechanism is located at and configured to connect the first ends of the first and second elongated structures. In some embodiments, the flexible sling connects to the second strut portion at the first ends of the first and second elongated structures. In some embodiments, at least one portion of the first and second strut portions are adjustable, extendable or telescoping. In some embodiments, the first strut portion comprises a foot portion located at the second end of the elongated structure, and the second strut portion comprises a foot portion positioned to connect the second ends of the first and second elongated structures. In some embodiments, the foot portions of the first and second strut portions form a tripod stance when the device is configured to the sling mode. In some embodiments, the first strut portion further comprises a hand grip portion.

### BRIEF DESCRIPTION OF THE DRAWINGS

The following detailed description of embodiments of the invention will be better understood when read in conjunction with the appended drawings. It should be understood, however, that the invention is not limited to the precise arrangements and instrumentalities of the embodiments shown in the drawings.

FIG. 1 depicts an exemplary crutch device.

FIGS. 2A-2E depict an exemplary crutch device showing different configurations or forms of the device, features of the device, and methods of use thereof.

FIGS. 3A-3D depict other exemplary crutch device designs.

FIGS. 4A-4J are a series of images depicting an exemplary crutch device prototype and a method of using thereof.

### DETAILED DESCRIPTION

It is to be understood that the figures and descriptions of the present invention have been simplified to illustrate elements that are relevant for a clear understanding of the present invention, while eliminating, for the purpose of clarity many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless otherwise specifically defined herein, all terms are to be given their broadest reasonable interpretation. This includes meanings implied from the specification as well as meanings understood by those skilled in the art and/or as defined in dictionaries, treatises, etc.

It is noted that, as used in this specification and the appended claims, the singular forms “a,”“an,”and “the”include plural referents unless otherwise specified. The term “includes” and/or “including,” when used in this specification, specify the presence of stated features, elements, and/or components, but do not preclude the presence or addition of one or more other features, steps, operations, elements, components, and/or groups thereof.

Relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then-described or as shown in the drawing figure under discussion. These relative terms are for convenience of description and normally are not intended to require a particular orientation in actuality. Terms including “inwardly” versus “outwardly,” “longitudinal” versus “lateral,” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The phrases “operatively” or “operably connected” indicates such an attachment, coupling, or connection that allows the pertinent structures to operate as intended by virtue of that relationship.

Reference throughout the specification to “one embodiment,” “an embodiment,” or “some embodiments” means that a particular feature, structure, or characteristic described in connection with at least one example of the subject matter is included in at least one example of the subject matter disclosed. Thus, the appearance of the phrases “in one embodiment,” “in an embodiment,” or “in some embodiments” in various places throughout the specification is not necessarily referring to the same embodiment. Further, the particular features, structures, or characteristics of “one embodiment,” “an embodiment,” or “some embodiments” may be combined in any suitable manner with each other to form additional embodiments of such combinations. It is intended that embodiments of the disclosed subject matter cover modifications and variations thereof. Terms such as “first,” “second,” “third,” etc., merely identify one of a number of portions, components, steps, operations, functions, and/or points of reference as disclosed herein, and likewise to not necessarily limit embodiments of the present disclosure to any particular configuration or orientation.

Moreover, throughout this disclosure, various aspects can be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6, and any whole and partial increments therebetween. This applies regardless of the breadth of the range. As used herein, the term “about” in reference to a measurable value, such as an amount, a temporal duration, and the like, is meant to encompass the specified value variations of plus or minus 20%, plus or minus 10%, plus or minus 5%, plus or minus 1%, and plus or minus 0.1% of the specified value, as such variations are appropriate and fit within the confines of a functional system.

The terms “proximal,” “distal,” “anterior,” “posterior,” “medial,” “lateral,” “superior,” and “inferior” are defined by their standard usage indicating a directional term of reference. For example, “proximal” refers to a position that is situated nearer to the center of a body or point of attachment or interest. In another example, “anterior” refers to the front of a body or structure, while “posterior” refers to the rear of a body or structure, in relation to a relative viewpoint. In another example, “medial” refers to the direction towards the midline of a body or structure, and “lateral” refers to the direction away from the midline of a body or structure. In some embodiments, “lateral” or “laterally” may refer to any sideways direction. In another example, “superior” refers to the top of a body or structure, while “inferior refers to the bottom of a body or structure. It should be understood, however, that the directional term of reference may be interpreted within the context of a specific body or structure, such that a directional term referring to a location in the context of the reference body or structure may remain consistent as the orientation of the body or structure changes.

Described herein is an invention that relates to crutches with enhanced functionality, combining mobility support, a fold-out leg and sling for injured leg elevation, and a telescoping frame that enables the crutch to be compactly folded for easy transportation and storage. The design is ideal for individuals recovering from leg injuries who require both portability and leg elevation while seated.

The device is designed to address two key challenges: providing leg elevation for users while seated and allowing the crutch to telescope into a compact form for ease of transportation and storage. Compared to current work in the field, the disclosed device provides multiple advantages. Utilizing a telescoping frame the device can collapse into a small and easily transportable form. The telescoping frame can collapse into a more portable size when the crutch is not needed for walking or when the sling is in use. This invention is ideal for users who need to carry a crutch during travel or store the crutch in tight spaces.

The device not only provides mobility support but also functions as a leg elevation device, offering a comprehensive solution for individuals recovering from leg injuries. Additionally, the telescoping feature, combined with a fold-out leg and sling, ensures that the crutch occupies minimal space both when it is being used for leg elevation and when it is stored. The invention provides users with the convenience of a portable, multi-functional mobility aid that can be used comfortably in various settings, promoting both recovery and ease of transportation. Unlike most current crutches, the disclosed device is also configured to allow the height of the device to be reduced while the leg of the user is elevated, thereby providing a more comfortable seated position without the bulk of a full-length crutch obstructing movement.

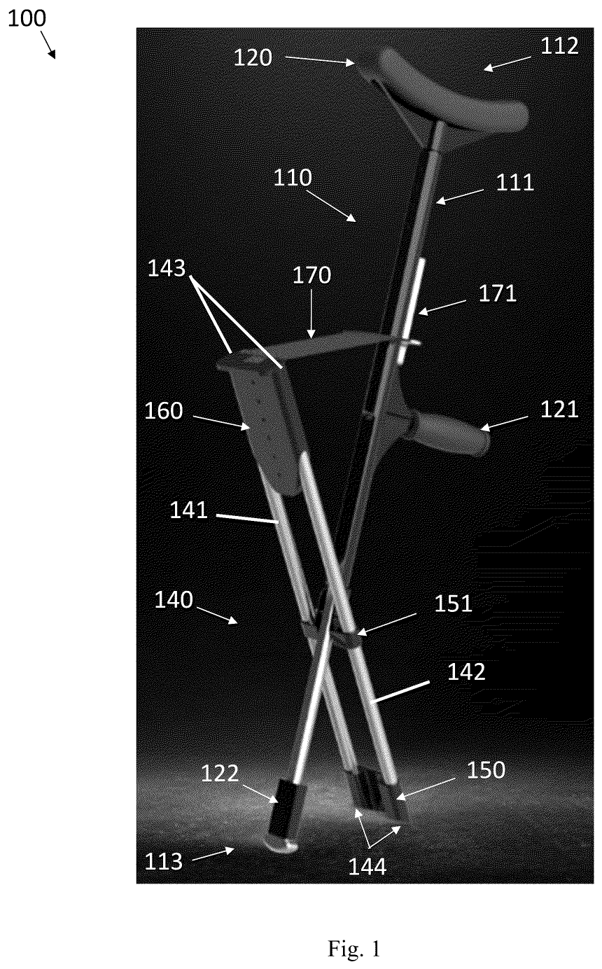

Referring now to FIG. 1 an exemplary crutch device 100 is shown. In some embodiments, the device 100 comprises a first strut portion 110, a second strut portion 140 and a flexible sling 170. The first strut portion 110 may comprise an elongated structure 111 with a first end 112 and second end 113, and the second strut portion 140 may comprise a first elongated structure 141 and a second elongated structure 142, both with a first end 143 and second end 144. The first strut portion 110 may be connected to the second strut portion 140 via a hinge 151. In some embodiments, the elongated structure 111 of the first strut portion 110 may be located between the first 141 and second 142 elongated structures of the second strut portion 140. In some embodiments, the flexible sling 170 is connected to the first 110 and second 140 strut portions.

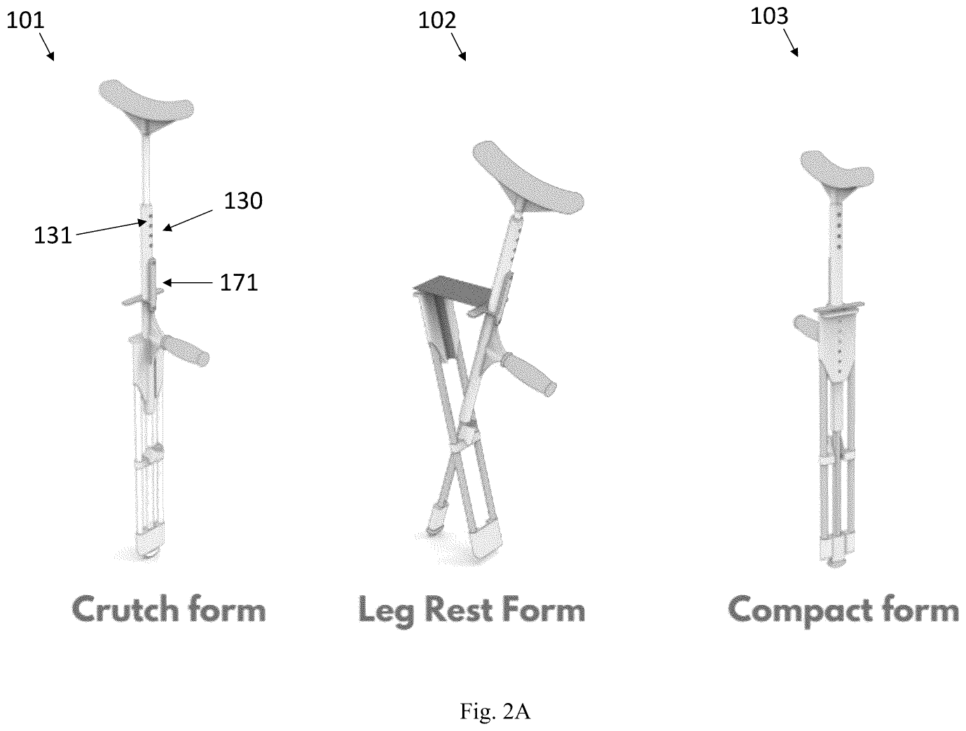

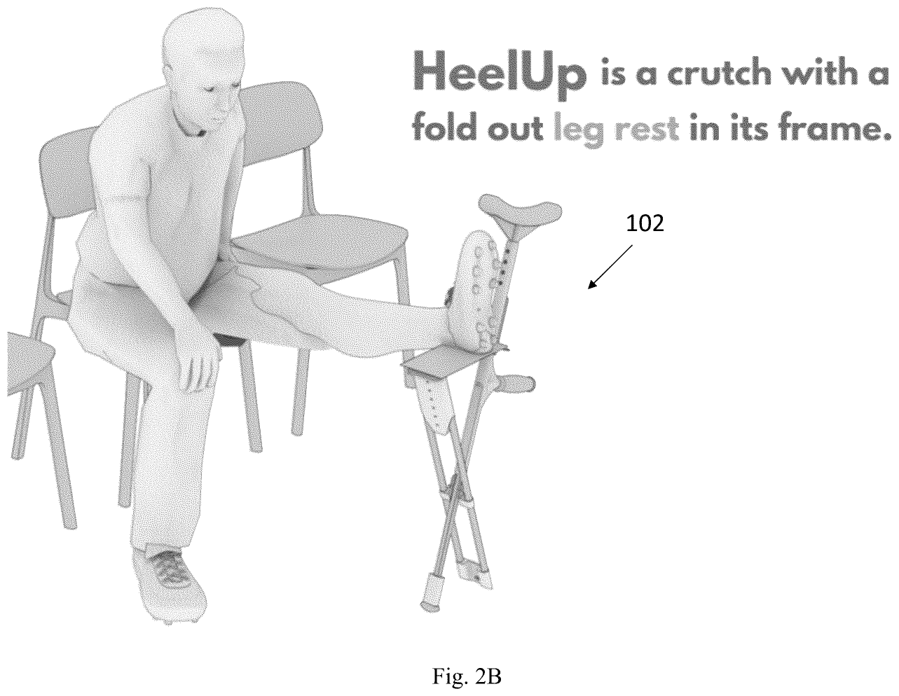

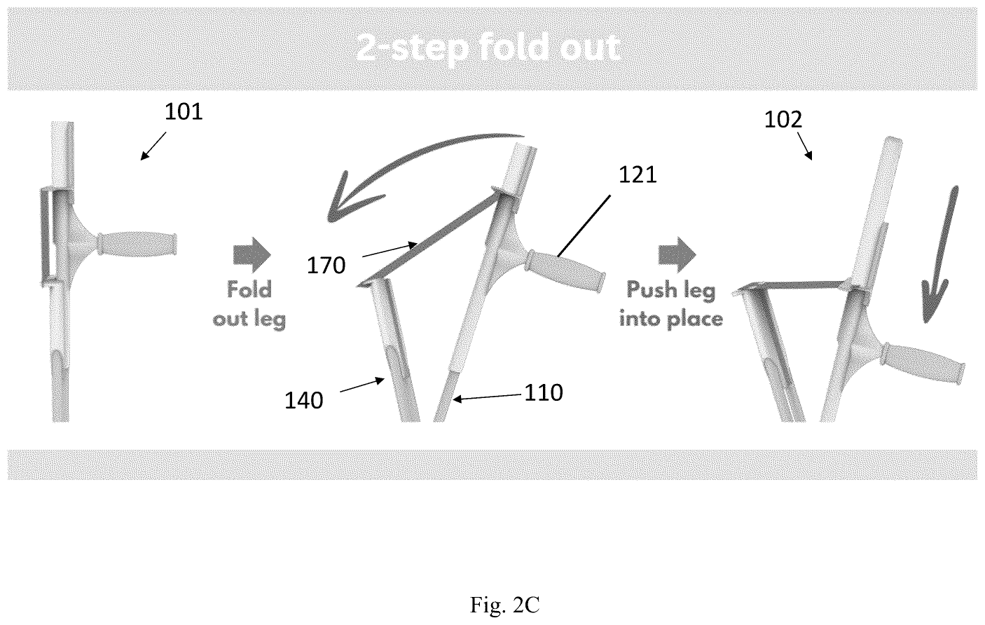

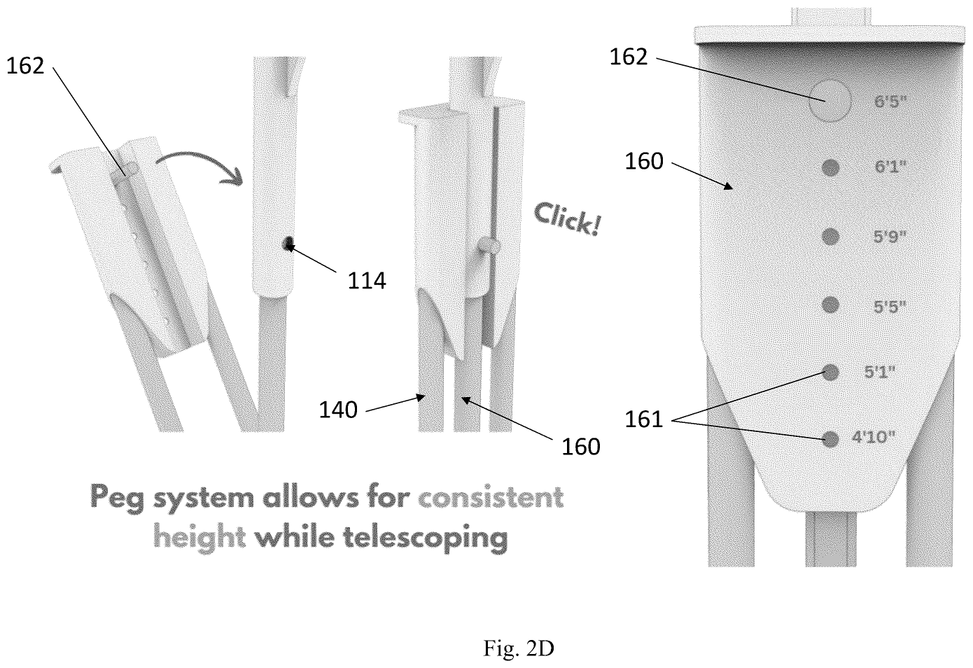

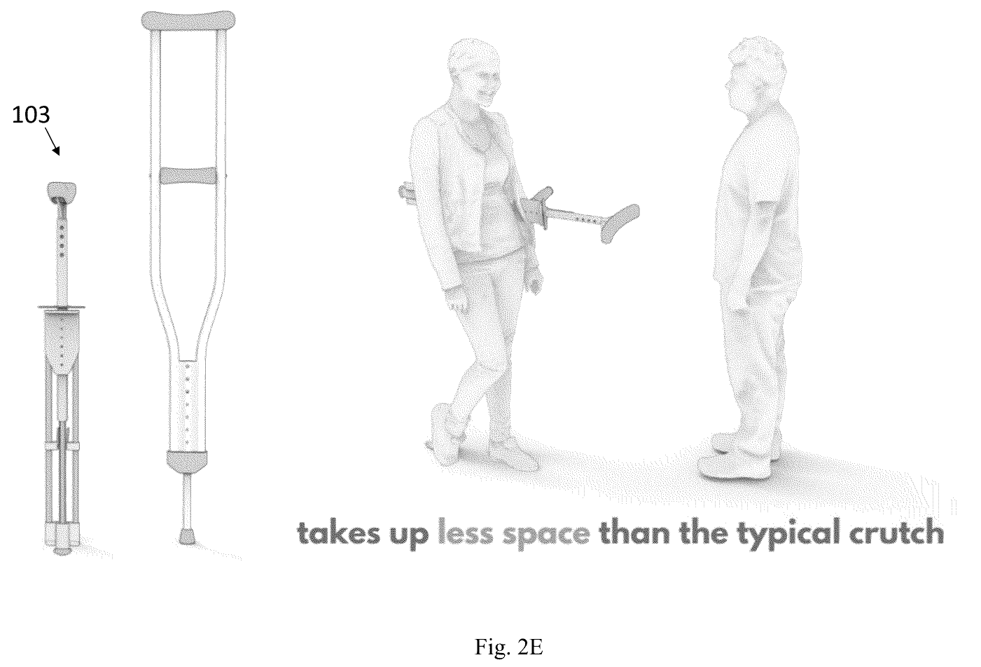

In some embodiments, the first end 112 of the first strut portion 110 comprises an underarm support 120. In some embodiments, the underarm support 120 may utilize cushions or any materials that may provide comfortable support for a user. The first strut portion 110 may further comprise a hand grip portion 121. In some embodiments, the second strut portion 140 comprises a locking mechanism 160 configured to engage and lock with the first strut portion 110 in both a crutch mode 101 and a compact mode 103 (see FIG. 2A). The locking mechanism 160 may be located at and configured to connect the first ends 143 of the first 141 and second 142 elongated structures. The flexible sling 170 may connect to the second strut portion 140 at the first ends 143 of the first 141 and second 142 elongated structures. The flexible sling 170 may be composed of a fabric, cushioned fabric, plastic, leather, or any combinations thereof. In some embodiments, the flexible sling 170 may have a length ranging between about 4″ and 14″.

In some embodiments, the first strut portion 110 comprises a foot portion 122 located at the second end 113 of the elongated structure 111, and the second strut portion 140 comprises a foot portion 150 positioned to connect the second ends 144 of the first 141 and second 142 elongated structures. In some embodiments, the foot portion 122 of the first strut portion 110 and the foot portion 150 of the second strut portion 140 may comprise a rubberized foot for traction and stability. In some embodiments, the first strut portion 110 may further comprise of a hand grip portion 121. In some embodiments, the foot portion 122 of the first strut portion 110 and/or the foot portion 150 of the second strut portion 140 may have rounded or curved portions. The hand grip portion 121 and the underarm support 120 may be composed of any suitable material that provides a gripping or cushioning function. In some embodiments, the hand grip portion 121 may be an ergonomic handle.

Referring now to FIG. 2A-2E, an exemplary crutch device 100 depicting different configurations or forms of the device 100, features of the device 100, and methods of use are shown. As shown in FIG. 2A, the device 100 may be configurable between a crutch mode 101, a sling mode 102 and a compact mode 103. In some embodiments, the foot portion 122 of the first strut portion 110 extends below the foot portion of the second strut portion 140 when the device 100 is configured to the crutch mode 101 or compact mode 103. In some embodiments, the device 100 may comprise of a telescoping frame 130 that is configured to adjust the height of the device 100. The telescoping frame 130 may include a plurality of apertures 131 configured to allow the elongated structure 111 to lock into place at a desired height of the device 100. The telescoping frame 130 may be any suitable or known telescoping or adjustable mechanism in the field. In some embodiments, the telescoping frame 130 may comprise a plurality of sliding sections. When in use as a standard mobility aid, the user may extend the telescoping frame 130 to full length by unlocking each section. The frame 130 locks securely at various points to ensure a stable walking experience.

In some embodiments, the foot portion 122 of the first strut portion 110 and the foot portion 150 of the second strut portion 140 may form a tripod stance when the device 100 is configured to the sling mode 102. The tripod stance may increase stability of the device 100. In some embodiments, the flexible sling 170 is positioned substantially parrel to the ground when the device 100 is configured to the sling mode 102. In some embodiments, an attachment element 171 may connect the flexible sling 170 to the first strut portion 110.

Any portion of the first 110 and second 140 strut portions may be adjustable, extendable or telescoping. In some embodiments, at least one portion of the first 110 and second 140 strut portions are adjustable, extendable or telescoping. The crutch mode 101 of the device may transform into the compact mode 103 of the device 100 by adjusting the height of the device 100. In some embodiments, the telescoping frame 130 and/or the locking mechanism 160 may be used to reduce the height of the device 100 to form the compact mode. The device 100 may be constructed from lightweight, durable materials and may include multiple sliding sections. Each section of the first strut portion 110 may telescope into the larger section above it, allowing the device 100 to collapse into a compact configuration for convenient transportation and storage when the device is not in use. The device 100 is configured to reduce the overall footprint of the device 100 when used in public places, thereby minimizing interference with surrounding individuals or objects. The telescoping mechanism, such as the telescoping frame 130, includes locking joints at each section to ensure stability and secure positioning when the device 100 is extended for walking or support.

FIG. 2B depicts an example of a user utilizing the device 100 in the sling mode 102. FIG. 2C illustrates a step-by-step method of transforming the device 100 from the crutch mode 101 to the sling mode 102. As shown, when moving into the sling mode 102, the second strut portion 140 may be folded out by pulling away from the first strut portion 110, and may be stabilized and pushed into place by pulling down the hand grip portion 121. In some embodiments, the second strut portion 140 is stored at the base of the first strut portion 110 and deployed when the user is seated and requires elevation of an injured leg. The weight of the leg may provide additional downward force that may stabilize the sling and lock the device 100 in place to maintain stability during use in the sling mode 102.

When the user sits, the second strut portion 140 may be deployed from the base of the device 100, and the flexible sling 170 may be attached. To maximize comfort, the telescoping frame 130 may be pushed downward to reduce the height of the device 100 while the leg is elevated on the flexible sling 170. The telescoping feature of the device 100 allows the device 100 to shrink to a size that is more comfortable for seated users while still supporting the elevated leg.

In some embodiments, the flexible sling 170 is stored compactly within the device 100. When the second strut portion 140 is extended, the flexible sling 170, attached to the first 110 and second 140 strut portions, may form a secure platform for the injured leg of the user. The device 100 may telescope into a shorter configuration when the flexible sling 170 is deployed, reducing the height of the device 100 and allowing for a more comfortable sitting position when the leg is elevated. The telescoping frame 130 may enable the height of the device 100 to be reduced when the flexible sling 170 is in use, ensuring the device 100 remains compact and non-obtrusive while providing elevation support. Once the user has finished using the device 100 for walking or leg elevation, the telescoping frame 130 may be collapsed fully, reducing the overall length of the device 100. The compact mode 103 may easily be stored in small spaces such as cars, trunks, closets, or bags, making the device 100 highly portable and convenient for travel.

FIG. 2D illustrates a step-by-step method of transforming the device 100 from the sling mode 102 to the crutch mode 101 or compact mode 103. In some embodiments, the locking mechanism 160 may be used to move from the sling mode 102 to the crutch mode 101 or compact mode 103. In some embodiments, the locking mechanism 160 may comprise of a plurality of apertures 161. In some embodiments, a pin 162 may engage with one of the plurality of apertures 161, and be used to lock into at least one aperture 114 disposed on the first strut portion 110. The locking mechanism of the pin 162 may operate similarly to a click-lock engagement. Any suitable locking mechanism may be used to secure the first strut portion 110 and the second strut portion 140 in place to form the crutch mode 101 or compact mode 103. In some embodiments, the plurality of apertures 161 correspond to different height positions, and the pin 162 may engage with one aperture of the plurality of apertures 161 to achieve a desire height of the device 100. Thus, the locking mechanism 160 may be used to adjust the height of the device 100. In some embodiments, the second strut portion 140 may be adjustable in height. In some embodiments, the flexible sling 170 may be formed from a flexible and durable material to comfortably support the injured leg of the user.

FIG. 2E depicts the device 100 in the compact mode 103 and illustrates an example of a user carrying the device 100 in the compact mode 103. As shown, the compact mode 103 allows the device 100 to be portable and easily storable as compared to other devices in the field. After using the device 100 in the crutch mode 101 or the sling mode 102, both the second strut portion 140 and the flexible sling 170 may be retracted into the body of the device 100, and/or the telescoping frame 130 may be telescoped into the compact mode 103. This allows the device 100 to be easily stored or carried, minimizing space requirements. The device 100 may be formed from one material or more materials that renders the device 100 lightweight for ease of carrying while being sufficiently robust to support the weight of the user.

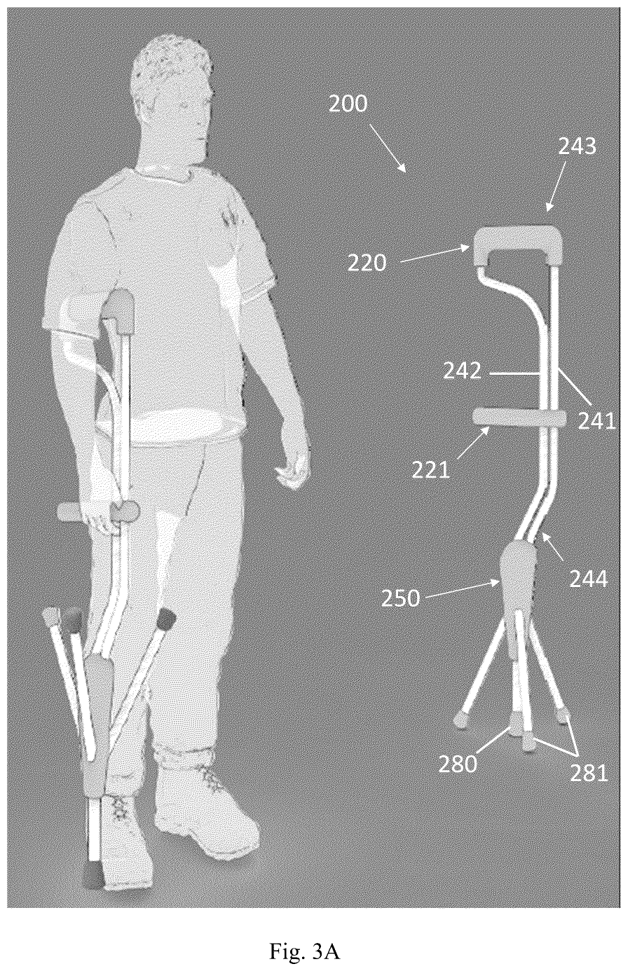

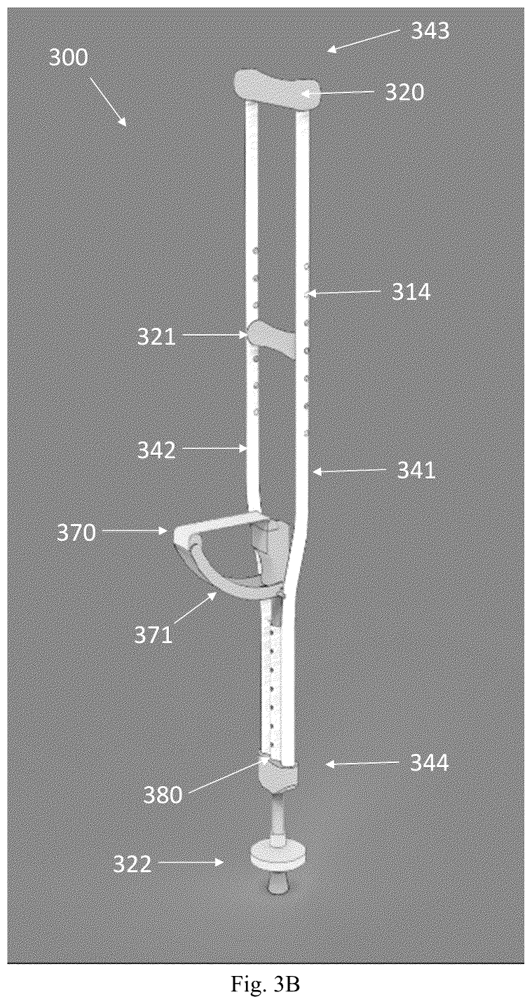

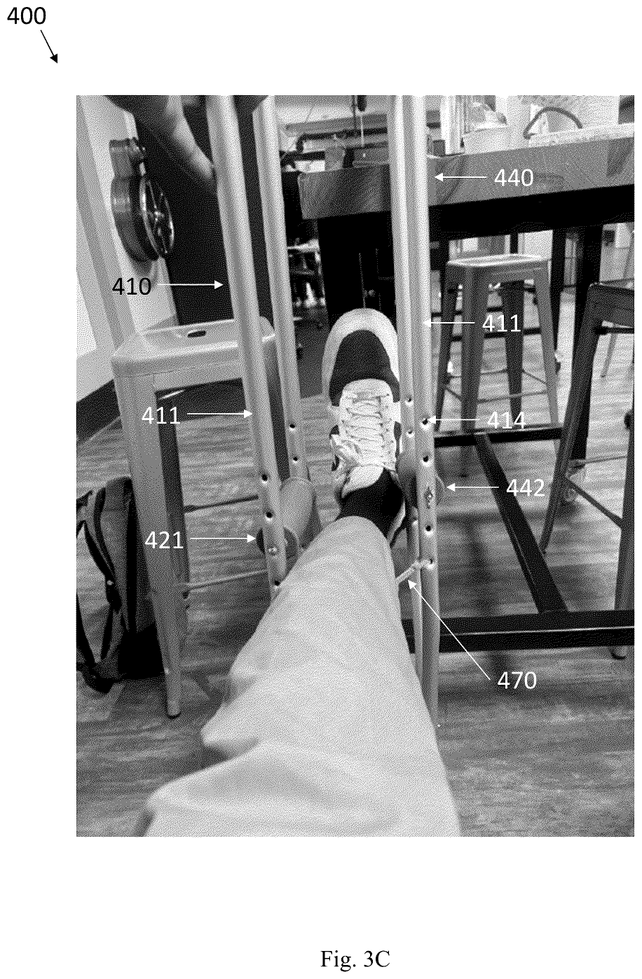

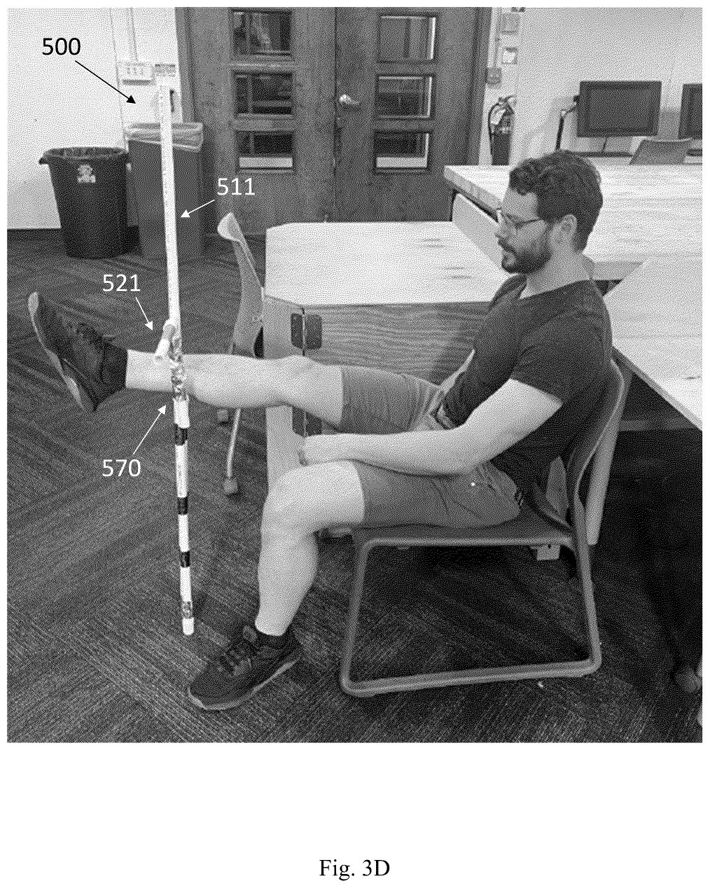

Referring now to FIGS. 3A-3D, other exemplary crutch device designs are shown. FIG. 3A depicts a crutch device 200 comprising a first elongated structure 241 and a second elongated structure 242, both with a first end 243 and second end 244. In some embodiments, the device 200 may further comprise an underarm support 220, located at and configured to connect the first ends 243 of the first 241 and second 242 elongated structures. In some embodiments, a connector 250 may be located at and configured to connect the second ends 244 of the first 241 and second 242 elongated structures. The device 200 may further comprise a hand grip portion 221 connected to one or both first 241 and second 242 elongated structures. In some embodiments, the position of the hand grip portion 221 is adjustable.

The device 200 may take any ergonomic form that provides ease of use and comfort to the user. In some embodiments, the first ends 243 of the first 241 and second 242 elongated structures may be spaced further apart to increase the stability and support of the user when the user leans on or places weight on the underarm support 220. The first 241 and second 242 elongated structures may converge closer together toward the hand grip portion 221 in such a way that allows the user to comfortably engage with the hand grip portion 221.

In some embodiments, the connector 250 may be further connected to a base support member 280 that is configured to contact the ground which the device 200 is in use. The device 200 may further comprise a plurality of support members 281 configured to provide additional stability to the device 200. In some embodiments, the plurality of support members 281 may be removeable via attach-and-detach mechanisms, foldable mechanisms, or adjustable positioning mechanisms, such that the plurality of support members 281 can be moved upward when not in use and extended downward to engage the ground when needed.

FIG. 3B depicts another crutch device 300 comprising a first elongated structure 341 and a second elongated structure 342, each having a first end 343 and second end 344. In some embodiments, the device 300 may further comprise an underarm support 320, positioned at and configured to connect the first ends 343 of the first 341 and second 342 elongated structures. In some embodiments, the device 300 may comprise a hand grip portion 321 that connects the first 341 and second 342 elongated structures. The second ends 344 of the first 341 and second 342 elongated structures may converge towards each other and connect at a foot portion 322. In some embodiments, the device 300 may further comprise of a flexible sling 370 supported by an attachment element 371. The attachment element 371 may engage with a third elongated structure 380 that may connect to the foot portion 322. In some embodiments, the third elongated structure 380 may be configured to allow the position of the flexible sling 370 to be adjusted. In some embodiments, the position of the hand grip portion 321 is adjustable by engaging with, for example, a plurality of apertures 314 disposed on the first 341 and second 342 elongated structures.

FIG. 3C illustrates a crutch device 400 comprising a first strut portion 410 and second strut portion 440. The first 410 and second 440 strut portions, each may comprise at least one elongated structure 411. In some embodiments, each of the first 410 and second 440 strut portions may include a hand grip portion 421 and an underarm support. In some embodiments, the device 400 may further comprise a flexible sling portion 470, connecting the first 410 and second 440 strut portions, and configured to support a leg of a user. The device 400 may be configured to fold or close to form a crutch mode, and the first 410 and second 440 strut portions may be separated or pulled apart from one another to expose the flexible sling portion 470, thereby forming a sling mode.

FIG. 3D depicts another crutch device 500 comprising at least one elongated structure 511, a hand grip portion 521 and a leg support member 570. In some embodiments, the position of the hand grip portion 521 is adjustable.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore are not to be construed as limiting in any way the remainder of the disclosure.

### Crutch with Integrated Fold-Out Sling, Telescoping Frame for Compact Transport, and Leg Elevation Mechanism

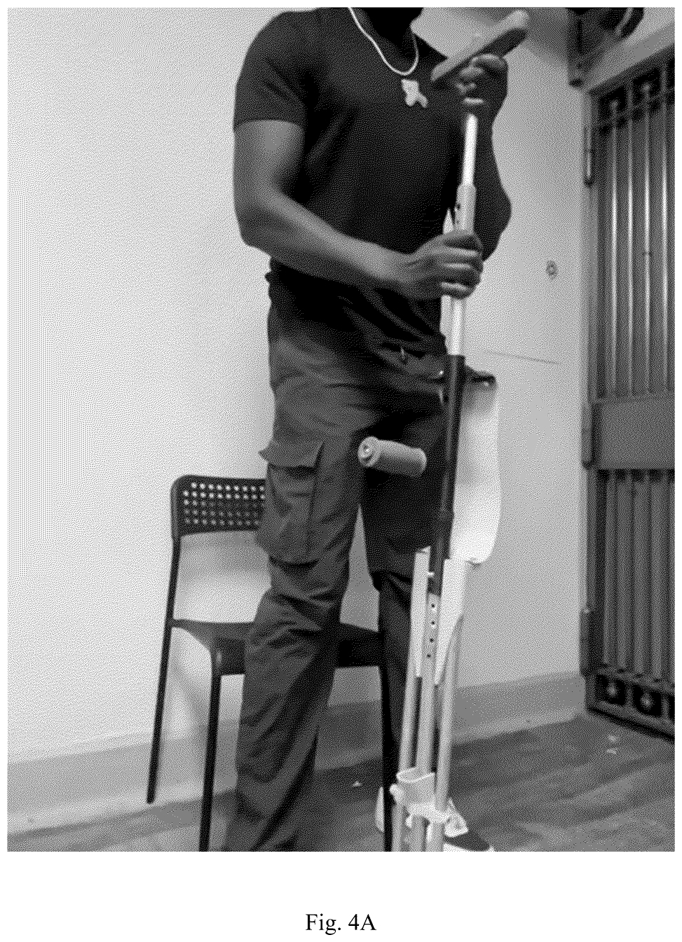

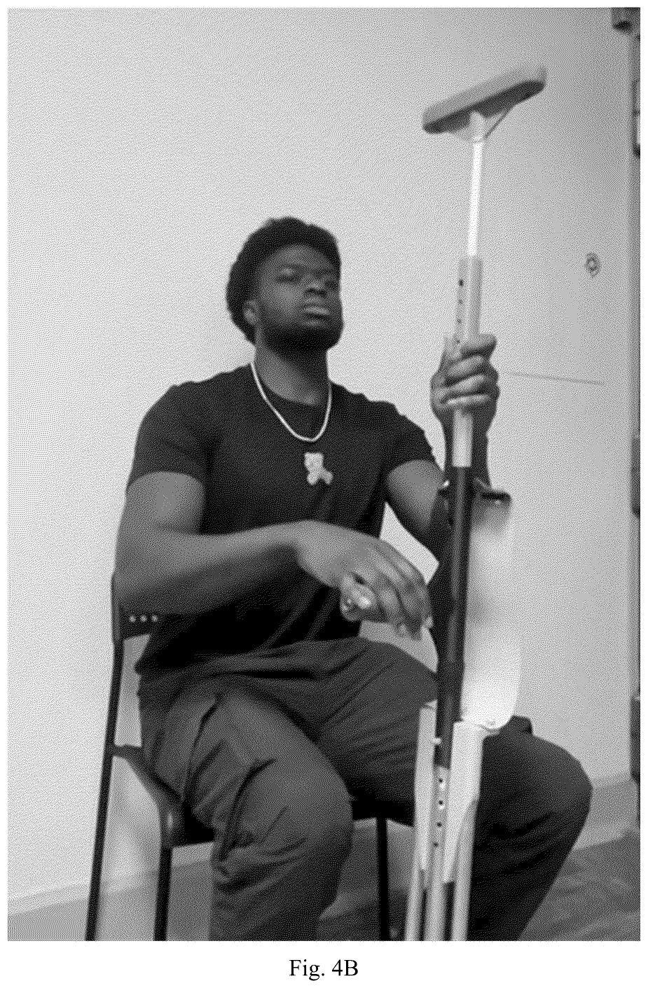

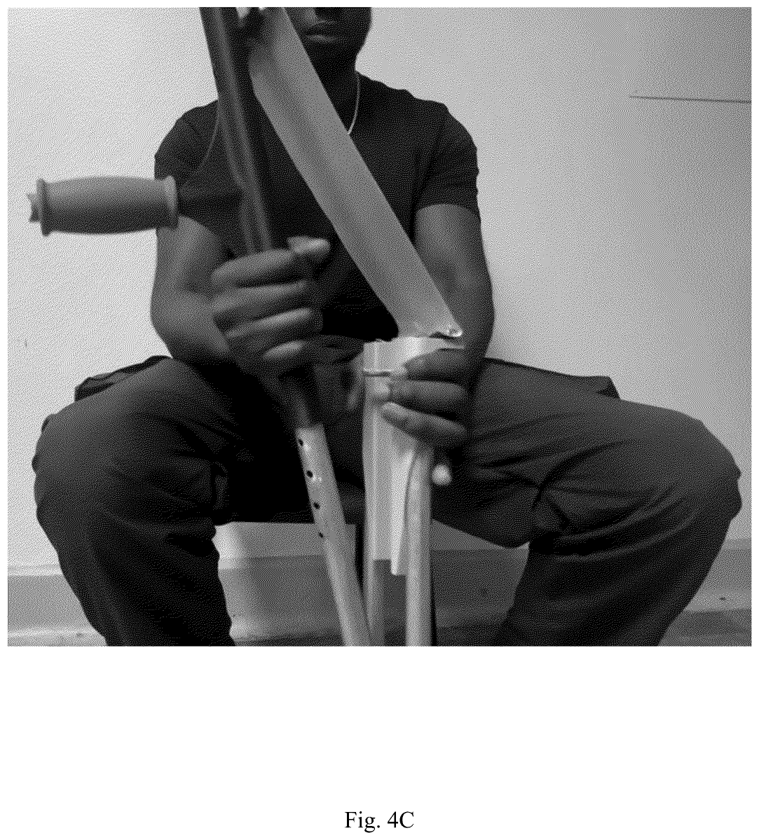

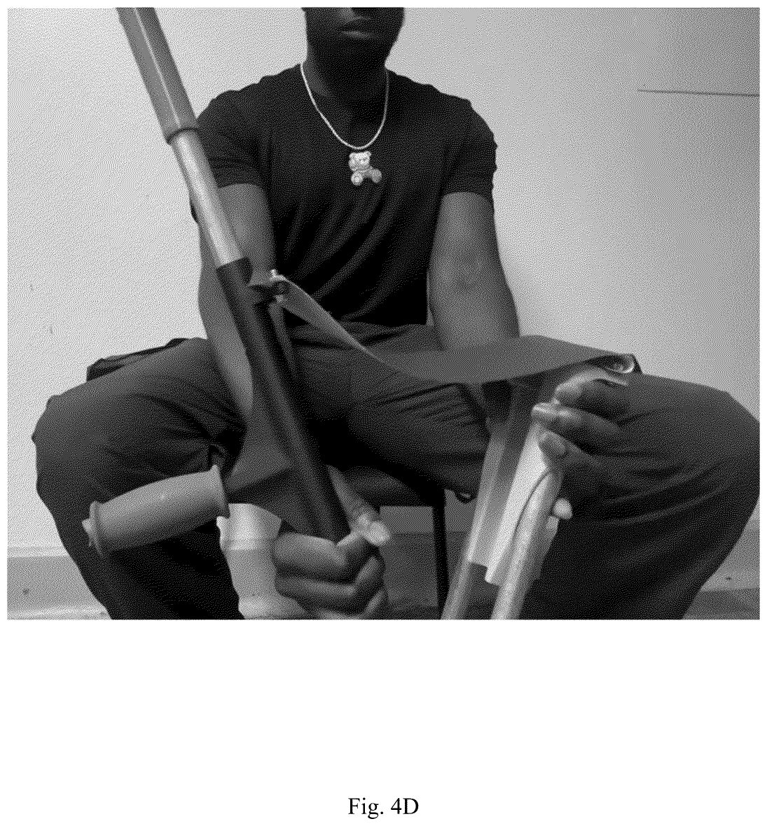

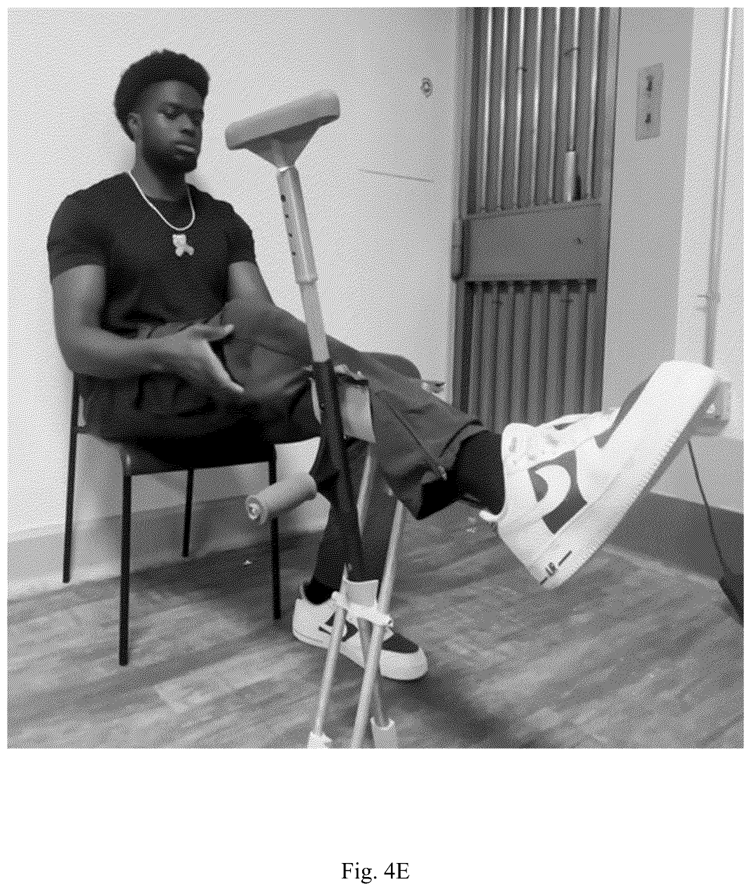

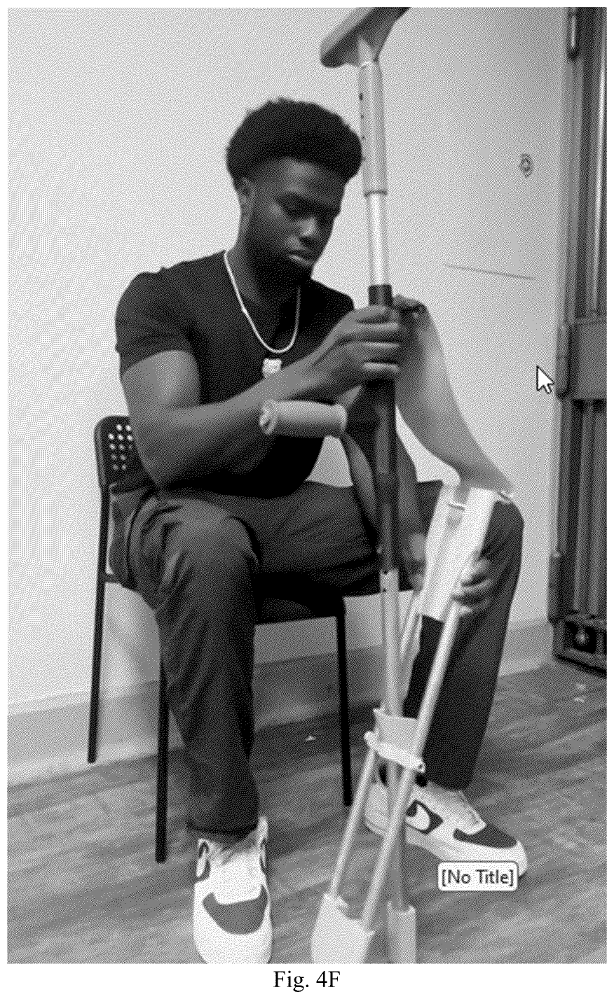

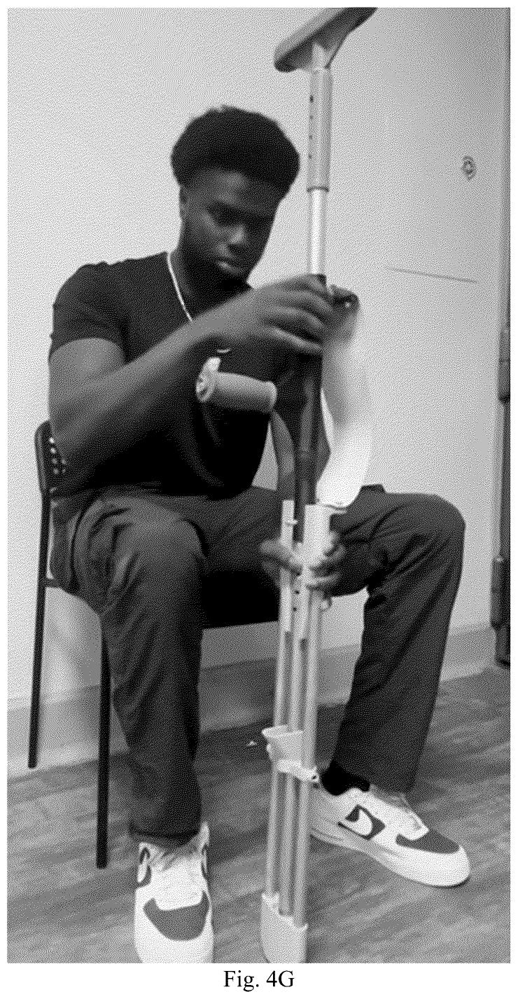

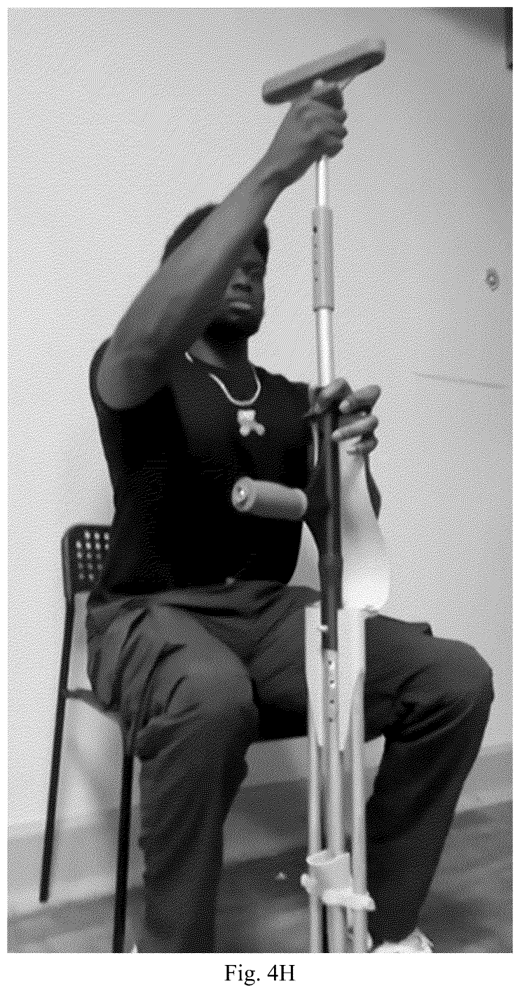

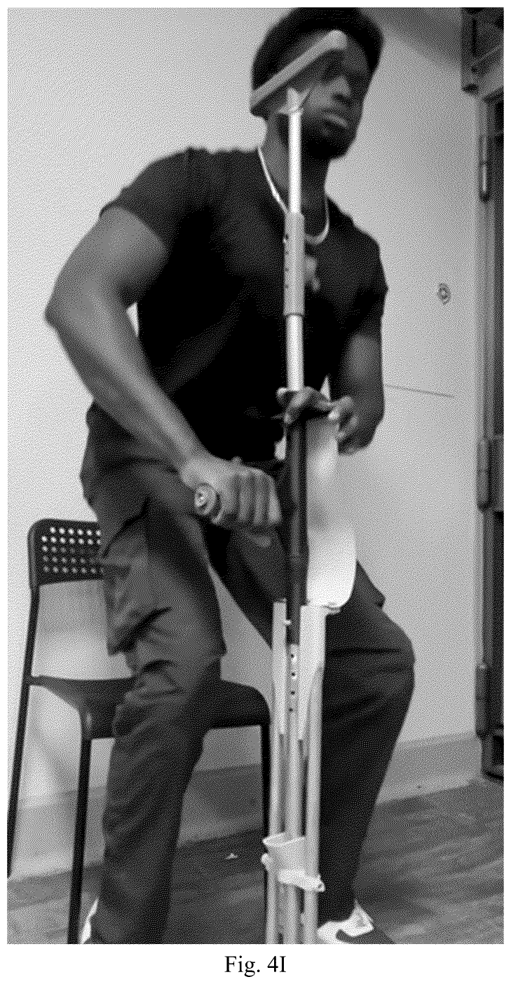

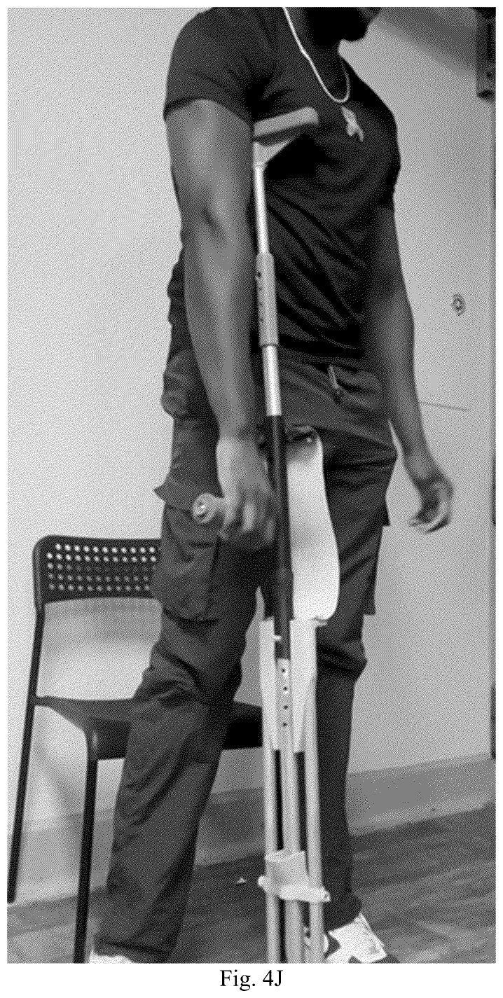

A manufactured prototype and method of use thereof for an exemplary telescopic crutch with stable leg rest is shown in FIGS. 4A-4J. In some embodiments, the disclosed crutch device is referred to as “HeelUp”.

FIG. 4A-4B depict the extension of the overall height of the crutch device using a telescoping frame mechanism. A sure is shown operating the telescoping frame to extend the device to the desired height.

FIG. 4C-4E depict the transformation of the device from a crutch mode to a sling mode. The user is shown separating and then stabilizing the first and second strut portions of the device to expose a flexible sling portion configured to support the leg of the user.

FIG. 4F-4G depict the collapsing or folding of the device, using a locking mechanism, to form the crutch mode. The user is shown engaging the locking mechanism to secure the first strut portion and second strut portions together, thereby creating a configuration suitable for use as a crutch.

FIG. 4H-4J depict the re-extension of the device from the collapsed state back into the crutch mode. The user is shown adjusting the device to a desired height for comfortable and stable use.

The disclosures of each and every patent, patent application, and publication cited herein are hereby each incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A crutch device, comprising:
a first strut portion connected to a second strut portion with a hinge; and
a flexible sling connected to the first and second strut portions, wherein the device is configurable between a crutch mode and a sling mode.

2. The device of claim 1, wherein the flexible sling is positioned substantially parrel to the ground when the device is configured to the sling mode.

3. The device of claim 1, wherein a foot portion of the first strut portion extends below a foot portion of the second strut portion when the device is configured to the crutch mode.

4. The device of claim 1, wherein the first strut portion is formed from an elongate tube or structure, and the second strut portion is formed from first and second elongate tubes or structures.

5. The device of claim 1, wherein the foot portions of the first and second strut portions form a tripod stance when the device is configured to the sling mode.

6. The device of claim 1, further comprising a hand grip portion attached to the first strut portion.

7. The device of claim 1, wherein any portion of the first and second strut portions are adjustable, extendable or telescoping.

8. The device of claim 1, wherein the flexible sling is composed of a fabric, cushioned fabric, plastic, leather, or any combinations thereof.

9. The device of claim 1, wherein the sling has a length ranging between about 4″ and 14″.

10. The device of claim 1, wherein the first strut comprises an underarm support.

11. A crutch device comprising:
a first strut portion, wherein the first strut portion comprises an elongated structure with a first end and second end;
a second strut portion, wherein the second strut portion is connected to the first strut portion via a hinge, and the second strut portion comprises a first elongated structure and a second elongated structure, each with a first end and second end; and
a flexible sling connected to the first and second strut portions, wherein the device is configurable between a crutch mode, a sling mode and a compact mode.

12. The device of claim 11, wherein the first end of the first strut portion comprises an underarm support.

13. The device of claim 12, wherein the first strut portion further comprises a hand grip portion.

14. The device of claim 13, wherein the second strut portion comprises a locking mechanism configured to engage and lock with the first strut portion in both the crutch mode and the compact mode.

15. The device of claim 14, wherein the locking mechanism is located at and configured to connect the first ends of the first and second elongated structures.

16. The device of claim 14, wherein the flexible sling connects to the second strut portion at the first ends of the first and second elongated structures.

17. The device of claim 14, wherein at least one portion of the first and second strut portions are adjustable, extendable or telescoping.

18. The device of claim 17, wherein the first strut portion comprises a foot portion located at the second end of the elongated structure, and the second strut portion comprises a foot portion positioned to connect the second ends of the first and second elongated structures.

19. The device of claim 18, wherein the foot portions of the first and second strut portions form a tripod stance when the device is configured to the sling mode.

20. The device of claim 19, wherein the first strut portion further comprises a hand grip portion.
